(19) United States
(12) Patent Application Publication
(10) Pub. No.: US 2018/0283981 A1
(43) Pub. Date: Oct. 4, 2018

(54) METHOD FOR DETERMINING THE REMAINING SERVICE LIFE OF A WIND TURBINE

(71) Applicant: Wobben Properties GmbH, Aurich (DE)

(72) Inventors: Albrecht BRENNER, Aurich (DE); Jan Carsten ZIEMS, Aurich (DE)

(21) Appl. No.: 15/562,391

(22) PCT Filed: Apr. 13, 2016
(86) PCT No.: PCT/EP2016/058068

§ 371 Date: Sep. 27, 2017

(30) Foreign Application Priority Data
Apr. 13, 2015 (DE) 10 2015 206 515.4

(51) Int. Cl. G01M 5/00; F03D 17/00

(52) U.S. Cl. CPC G01M 5/0066; F03D 17/00; G01M 5/0016; F05B 2270/331; G01M 5/0041; F05B 2260/80; G01M 5/0025

(57) ABSTRACT

A method for determining a remaining lifetime of a wind turbine is disclosed. The method includes continuous recording of movements or oscillations of components of the wind turbine using sensors during operation of the wind energy converter, as well as determining modes and frequencies of the movements or oscillations. Determination of the forces acting on the components of the wind turbine is furthermore carried out based on a model, in particular a numerical model, of the wind energy converter, as well as determination of stress and/or load spectra of the components of the wind turbine. The method furthermore comprises determination or estimation of a remaining lifetime by comparison of the determined stress and/or load spectra with overall stress and overall load spectra.

### BACKGROUND

### Technical Field

The present invention relates to a method for determining a remaining lifetime of a wind turbine.

### Description of the Related Art

During the development of a wind turbine, the respective components of the wind turbine are configured in such a way that the wind turbine can have a lifetime of, for example, 20 or 25 years, i.e., the respective components of the wind turbine are configured in such a way that operation of the wind turbine for the projected lifetime is possible.

Each wind turbine is exposed to steady and non-steady stresses. The non-steady stresses may for example be caused by wind turbulence, oblique incident flows and a height profile of the wind speed. The range of stresses acting on the wind turbine is therefore diverse, and the respective stress situations is evaluated in their entirety. This is done by means of load spectra which represent the sum of the stress situations. The non-steady stresses acting on the wind turbine lead to fatigue of the components of the wind turbine. Each component of the wind turbine is configured in such a way that maximum fatigue is not to be reached until the lifetime of the wind turbine is reached.

EP 1 674 724 B1 describes a device and a method for determining fatigue loads of a wind turbine. In this case, a tower fatigue load analysis is carried out on the basis of measurements of sensors on the wind turbine. The results of the fatigue analysis are subjected to a spectral frequency analysis in order to estimate damage to the foundation of the wind turbine. With the aid of the tower fatigue analysis, an estimate of lifetime information is carried out.

The German Patent and Trade Mark Office has investigated the following documents in the German patent application on which the priority is based: DE 102 57 793 A1, DE 10 2011 112 627 A1, EP 1 760 311 A2 as well as Lachmann, St.: “Kontinuierliches Monitoring zur Schädigungsverfolgung an Tragstrukturen von Windenergieanlagen” [Continuous monitoring for damage tracking on support structures of wind turbines].

### BRIEF SUMMARY

An improved method for determining a remaining lifetime of a wind turbine is provided.

A method for determining the currently elapsed lifetime consumption of a wind turbine is provided.

A method is therefore provided for determining a remaining lifetime of a wind turbine. By means of sensors, movements or oscillations are recorded continuously during operation of the wind turbine. Modes and frequencies of the movements or oscillations are determined. The forces acting on the components of the wind turbine are determined on the basis of a model, in particular a numerical model, of the wind turbine. Stress and/or load spectra of the components of the wind turbine are determined. A remaining lifetime is compared by comparison of the determined stress and/or load spectra with overall stress and/or overall load spectra.

Provided are continuous determination or calculation of the time-dependent participation factors of the relevant modes and determination therefrom of the movement or oscillation of the components, in particular by superpositioning of the time-dependent participation factors, is carried out in order to form the time-dependent overall deformation state.

Provided is a method for determining at least one load spectrum or stress spectrum of a wind turbine or of a component of a wind turbine, in order to determine a remaining lifetime or lifetime consumption therefrom. Movements of components of the wind turbine are recorded by means of sensors during operation of the wind turbine. Modes and frequencies of the movements are determined. The forces acting on the components may be determined on the basis of a beam model of the wind turbine or of components of the wind turbine. Stresses and load spectra of the components of the wind turbine are determined. A remaining lifetime of the wind turbine can be determined or estimated by comparison of the determined stresses and load spectra with overall stresses and overall load spectra.

A method is therefore provided for determining a remaining lifetime of a wind turbine. By means of sensors, movements or oscillations of components of the wind turbine are recorded continuously at selected sensor positions during operation of the wind turbine. The eigenfrequencies and eigenmodes of the movements or oscillations of the components of the wind turbine are determined. With knowledge of the relevant eigenmodes of the components of the wind turbine, the time-dependent participation factors can then be determined continuously and superposed in order to form the time-dependent overall deformation state of the component of the wind turbine. By a successive component-wise procedure starting from the foundation of the wind turbine, i.e., initially considering the tower and subsequently considering the rotor blades, the relevant movements or oscillations of the sensor positions can thus be determined and the time-dependent overall deformation state of the components of the wind turbine can be determined therefrom by means of the eigenmodes and the time-dependent participation factors. By the component-wise successive procedure, the relative movements or oscillations of the components of the wind turbine can be determined, and the time-dependent overall deformation state of the components of the wind turbine can be determined therefrom. The combination of the time-dependent overall deformation states of the components of the wind turbine gives the time-dependent overall deformation state of the wind turbine. On the basis of a model of the wind turbine, in particular a numerical model of the wind turbine, and the time-dependent overall deformation state of the wind turbine, the internal variables acting in the wind turbine in the sense of internal forces and internal moments can then be determined. The internal load spectra at relevant positions of the wind turbine are then determined from these internal variables. By comparison with associated maximum supportable internal load spectra at these relevant positions, it is then possible to determine or estimate a current lifetime usage and/or a remaining lifetime of the wind turbine.

Provided is a method for determining at least one internal load spectrum at at least one position of a wind turbine, in order to determine a remaining lifetime or a lifetime usage therefrom. By means of sensors, which are arranged at the relevant positions of the wind turbine, movements or oscillations of components of the wind turbine at the sensor positions are recorded. Eigenfrequencies and eigenmodes of the components of the wind turbine are determined therefrom. The relative movements of the components of the wind turbine are determined and combined continuously to form an overall deformation state of the wind turbine. The internal variables acting in the wind turbine are determined on the basis of a numerical model of the wind turbine, for example a beam model of the wind turbine, and internal variable spectra are calculated therefrom from the resulting time series. In this case, internal variables are intended in particular to mean internal forces and internal moments. By comparison of the determined internal variable spectra with associated maximum supportable internal variable spectra, a remaining lifetime of the wind energy converter can be determined or estimated. In particular, the current cumulative lifetime consumption can be determined with these spectra. It has furthermore been discovered that a substantial part of the configuration process of a wind turbine consists in the so-called load calculation. In this case, internal variables occurring at various positions of the wind turbine under the effect of external loads are determined. The internal variables occurring are in this case to be understood in the sense of internal forces and internal moments. The cyclic proportion of the internal variables is to this end represented either as time series and/or in the form of internal load spectra, and is used as a basis for the constituent part configuration in terms of the fatigue configuration of the individual constituent parts. By suitable sensor systems, i.e., selection of the sensors and their application position, it is possible to record these time series and internal load spectra precisely, specifically not as a directly measured signal but by taking into account a model of the wind turbine. The internal loads of the wind turbine are, therefore, recorded, in particular indirectly.

According to one aspect, for example, owing to the rotor rotation and the different pitch and azimuth angles, the per se nonlinear model for the current respective pitch, azimuth and/or rotor positions is thus frozen and regarded as a linear system for this instant. Continuous repetition of this instantaneous acquisition at defined time intervals then likewise gives a time series of the desired variables.

Treatment as an instantaneously linear system leads to a matrix formulation on the basis of likewise linear equation systems. The information content of such systems is fully described by a set of orthogonal eigenvectors, in which case the eigenvectors may relate to any desired support matrix, for example a mass matrix, unit matrix or other freely selectable basis.

Each state which can be represented by the linearized system may be expressed as a linear combination of weighted eigenvectors. Each eigenvector in this case has an individual participation factor applied to it before the superposition.

The purpose of the sensor systems, in combination with the proposed formulation, is in this case to determine the participation factors for sufficiently accurate reconstruction of the instantaneous linearized system state. The external effects by which this system state is caused are unimportant for this procedure, and are also unimportant in the sense of the purpose of determining the internal variables. The internal variables are therefore determined.

Use is in this case made of the fact that the determination of the eigenvectors does not have to be carried out online, but may be calculated beforehand for storage as a time-independent system property of the wind turbine being considered, and may be called up for use from a data memory in the determination of the participation factors.

Furthermore, use is in this case made of the fact that for sufficiently accurate representation of the internal variable profiles, not all the eigenvectors are used, but in general only very few, and specifically the long-wavelength eigenvectors, in particular the longest-wavelength eigenvectors. The participation factors of higher, i.e., short-wavelength eigenvectors are generally so small that these eigenvectors make only a small, negligible contribution to the superposed instantaneous solution.

In order to carry out the method, displacement or rotation signals which give the displacement and/or rotation state of individual free values of the linear instantaneous system are used at every time. These may be determined either directly by means of suitable measurement variable sensors or indirectly, for instance by integration of acceleration or speed measurement values.

The position and orientation of the measurement sensors should in principle be suitable to be able to measure components of the relevant eigenvectors. In this case, however, it is not necessary to comply with exact positions or directions since the proposed algorithm for determining the participation factors is based on minimization of the weighted sum between the measurement variable and the eigenvector at the position of the measurement sensor, and gives a good approximation of the participation factors even in the event of non-optimal measurement sensor positions. The number of sensors should in this case correspond at least to the number of relevant eigenvectors whose participation factors are intended to be determined. In the case of a number larger than this, the accuracy of the method is increased.

When the participation factors at the current time are provided, the system state can be determined with the associated eigenvectors and the desired internal variables are available for the current time.

The process is repeated continuously until the internal variables determined in this way form a time series in a similar way as in the load calculation for configuring the WT, with the difference that the time series determined in this way are determined on the basis of actual stresses and not on the basis of stresses assumed for the configuration.

An exemplary calculation procedure according to one embodiment will now be presented below:

At a particular time, at which the rotor position, the pitch position and/or the azimuth position of the converter are known, there is a set of eigenvectors V for this configuration, with which the converter state z is described by weighted superposition with the participation factors α of these eigenvectors:

z=V*α

In this case, in practice, the full set of eigenvectors is not used, but rather a suitably selected subset thereof, which essentially contains only the long-wavelength eigenvectors.

By means of a selector matrix Sₘ, a truncated set of these eigenvectors Vₘ is defined, which now only contains the free values for which the measurement values M from the planned sensor systems are available.

Vₘ=Sₘ*V

The least squares sum between the current measurement values M and the associated truncated state vector zₘ with:

zₘ=Sₘ*V*∝

is intended to be minimal, which at each time step gives a linear equation system for determining the desired participation factors α:

Vₘ^{t}*Sₘ^{t}*Sₘ*Vₘ*α=Vₘ^{t}*Sₘ*M.

This evaluation is to be carried out at each time step. It gives a time series of the participation factors α and, after superposition of the eigenvectors V weighted with α, a time series of the state vector z. From this state vector, the desired time series of the system internal variables can then be determined, counted by suitable algorithms, for example the rainflow method or other methods, and used for the calculation of the lifetime consumption.

### BRIEF DESCRIPTION OF THE SEVERAL VIEWS OF THE DRAWINGS

Advantages and exemplary embodiments of the invention will be explained in more detail below with reference to the drawing.

FIG. 1 shows a schematic representation of a wind turbine,

FIG. 2 shows a simplified schematic representation of a wind turbine,

FIG. 3 shows a simplified schematic representation of a wind turbine and possible movements of the wind turbine, and

FIG. 4 shows a flowchart of a method for determining a remaining lifetime of a wind turbine.

### DETAILED DESCRIPTION

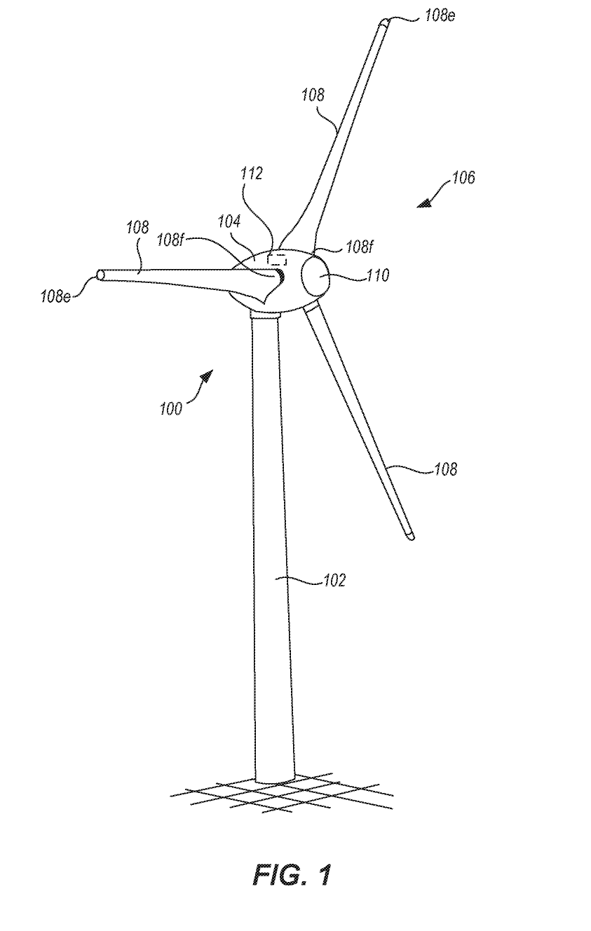

FIG. 1 shows a schematic representation of a wind turbine. The wind turbine 100 comprises a tower 102 and a nacelle 104. A rotor 106, having three rotor blades 108 and a spinner 110, is provided on the nacelle 104. The rotor blades 108 respectively have a rotor blade tip 108e and a rotor blade root 108f The rotor blade 108 is fastened to a hub of the rotor 106 at the rotor blade root 108f During operation, the rotor 106 is set in a rotational movement by the wind and therefore also directly or indirectly rotates a rotor of an electrical generator in the nacelle 104. The pitch angle of the rotor blades 108 can be modified by pitch motors at the rotor blade roots of the respective rotor blades 108.

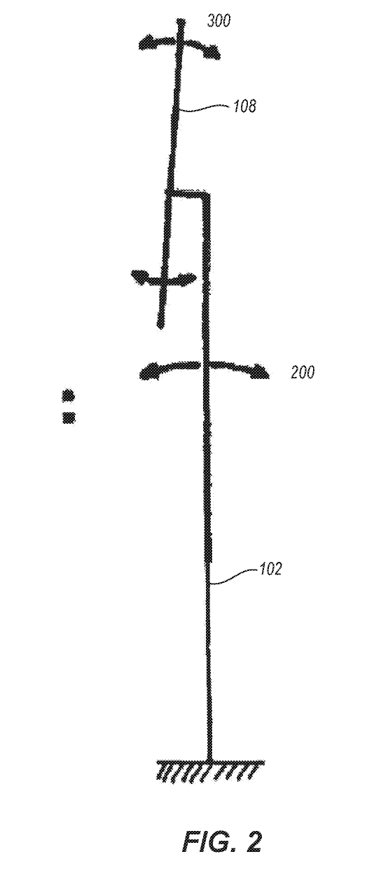

FIG. 2 shows a simplified schematic representation of a wind turbine. The wind turbine 100 comprises a tower 102 which is exposed to oscillations or movements 200, and rotor blades 108 which are exposed to oscillations or movements 300.

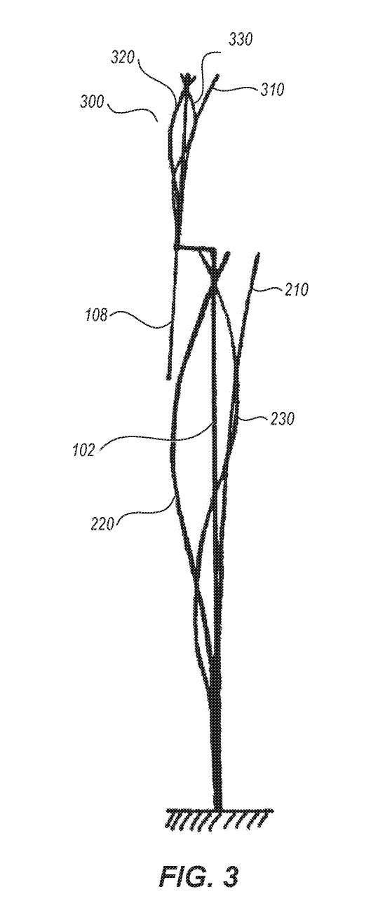

FIG. 3 shows a simplified schematic representation of a wind turbine and possible movements of the wind turbine. The tower 102 of the wind turbine may be exposed to different movements or oscillations 210, 220, 230. The rotor blades 108 of the wind turbine may be exposed to different movements or oscillations 310, 320, 330.

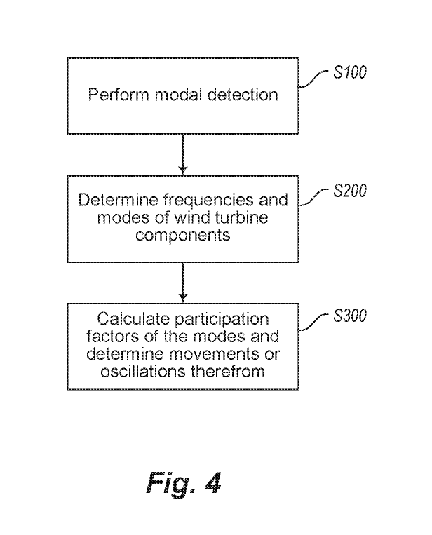

FIG. 4 shows a flowchart of a method for determining a remaining lifetime of a wind turbine. In Step S100, modal detection is carried out on the basis of measurement data of sensors in or on the wind turbine 100 (see sensors 112 in FIG. 1) during operation of the wind turbine 100, a decoupled modal decomposition being carried out into the modes of the components of the wind turbine, which are modelled as beams. The positions of the acceleration or extension sensors may be determined from a beam model of the wind turbine (with correspondingly defined stiffnesses and masses).

In Step S200, determination of the frequencies and the modes of the components of the wind turbine is carried out.

In Step S300, participation factors of the modes are calculated (continuously), and the movements or oscillations of the components are determined therefrom. Relative accelerations of the components, the modes of the components, and the participation factors of the modes, as well as subsequently relative movements of the components, can therefore be determined.

Accordingly, the movements or oscillations of the components of the wind turbine can be calculated continuously in a model, in particular a numerical model, specifically on the basis of the currently determined measurement data of the sensors in or on the wind turbine. Current internal forces and internal moments, which act on the components of the wind turbine, can be determined on the basis of the model, in particular the calculated model or calculation model, and the relative movements of the components of the wind turbines.

The determined internal forces and/or internal moments may be stored, in order to be able to compile stress/time diagrams therefrom. On the basis of the stored internal forces and/or internal moments, load spectra or stress spectra can be determined. The remaining lifetime or the lifetime consumption can be determined, for example continuously, from the load or stress spectra, so that exact determination of the remaining lifetime is possible.

According to one aspect, by continuous recording of the modes of the components of the wind turbine, extreme loads can be recorded and logged. Furthermore, in the event of a modification of the modes of the components of the wind turbine, conclusions may be possible regarding the state of the wind turbine.

According to another embodiment, in Step S200 participation factors of the modes are calculated and the movements or oscillations of the components are determined therefrom. This is done successively starting from the foundation, i.e., first for the tower and then for the rotor blades. Relative accelerations of the components, the modes of the components, and the participation factors of the modes, as well as subsequently relative movements of the components, can therefore be determined. The time-dependent overall deformation state of the overall wind turbine is formed therefrom. Preferably, the participation factors are, to this end, calculated continuously.

Subsequently, in Step S300 the internal variables, i.e., the internal forces and the internal moments, at relative positions of the wind turbine are calculated by means of a numerical model of the wind turbine, for example, a beam model of the wind turbine, and the time-dependent overall deformation state of the wind turbine. Internal load spectra for relevant positions of the wind turbine are formed from the resulting time series.

The movements or oscillations of the components of the wind turbine, and therefore also of the overall wind turbine, can therefore be calculated continuously in a numerical model, specifically on the basis of the currently determined measurement data of the sensors in or on the wind turbine. Current internal forces and internal moments, which act in the wind turbine, can be determined on the basis of the calculation model and the overall deformations of the wind turbine.

The determined internal forces and/or internal moments may be stored, in order to be able to compile stress/time diagrams therefrom. On the basis of the stored internal forces and/or internal moments, load spectra or stress spectra can be determined. From the load or stress spectra, the lifetime consumption can be determined, in particular continuously, by means of comparison with maximum supportable spectra, so that a prognosis of the remaining lifetime is possible.

According to one aspect, extreme loads can be recorded and logged by continuous recording of the overall deformation of the wind turbine. Furthermore, in the event of a modification of the eigenmodes and/or eigenfrequencies of the components of the wind turbine, conclusions about the state of the wind turbine may be possible.

A method for determining a remaining lifetime of a wind turbine is provided. The method comprises continuous recording by means of sensors of movements or oscillations of components (tower, rotor blades) of the wind turbine (WT) at selected sensor positions during operation of the WT. Furthermore, determination of eigenfrequencies and eigenmodes of the movements or oscillations of the components of the WT is performed. In addition, the time-dependent participation factors of the relevant eigenmodes of the components of the WT are determined continuously (from the movements or oscillations of the components of the WT at selected sensor positions) and the time-dependent overall deformation state is calculated by superposition. Furthermore, the method comprises continuous determination of the internal variables acting in the WT in the sense of internal forces and moments on the basis of a numerical model of the WT and the time-dependent overall deformation state. It furthermore includes the determination of internal load spectra at relevant positions of the WT and the determination or estimation of the current lifetime consumption and/or a remaining lifetime by comparison of the determined internal load spectra with associated maximum supportable internal load spectra.

Time series and spectra are recorded by means of suitable sensor systems, specifically not as a directly measured signal but by using an overall mechanical model of the WT which is in any case used for the load calculation.

1. A method for determining a remaining lifetime of a wind turbine, comprising:
continuously recording movements or oscillations of components of the wind turbine using sensors during operation of the wind turbine;
determining modes and frequencies of the movements or oscillations;
determining forces acting on the components of the wind turbine based on a numerical model of the wind turbine;
determining at least one of stress and load spectra of the components of the wind turbine; and
determining or estimating a remaining lifetime by comparing at least one of the determined stress and the determined load spectra with at least one of an overall stress and an overall load spectra.

2. The method according to claim 1, comprising:
continuously determining or calculating time-dependent participation factors of relevant modes;
determining, based on the time-dependent participation factors, the movements or oscillations of the components of the wind turbine.

3. The method according to claim 1, wherein continuously recording the movements or oscillations includes:
recoding the movements or oscillations of a tower of the wind turbine and/or of rotor blades of the wind turbine using the sensors, wherein the sensors are arranged at selected sensor positions on the wind turbine.

4. The method according to claim 11, comprising:
continuously determining internal variables acting in the wind turbine based on at least one of the numerical model of the wind turbine energy converter and the time-dependent overall deformation state.

5. The method according to claim 1, comprising:
determining internal load spectra at relevant positions of the wind turbine that reflect loads of the wind energy converter.

6. The method according to claim 5, comprising:
determining or estimating a current lifetime consumption of the wind turbine by comparing the determined internal load spectra with a corresponding maximum supportable internal load spectra.

7. The method according to claim 6, wherein the determination or estimation of the remaining lifetime by comparing the determined at least one of stress and load spectra with at least one of the overall stress and the overall load spectra includes comparing the determined internal load spectra with the corresponding maximum supportable internal load spectra.

8. The method according to claim 1, wherein a number of the sensors corresponds at least to a number of relevant eigenvectors whose participation factors are determined.

9. A method, comprising:
continuously determining, using sensors at selected sensor positions, movements or oscillations of components of a wind turbine during operation of the wind turbine;
determining at least one of eigenfrequencies and eigenmodes of the movements or the oscillations of the components of the wind turbine;
continuously determining time-dependent participation factors of relevant eigenmodes of the components of the wind turbine from the movements or oscillations of the components of the wind turbine at the selected sensor positions;
superpositioning the time-dependent participation factors to form a time-dependent overall deformation state;
continuously determining internal variables acting in the wind turbine as internal forces and/or moments based on a numerical model of the wind energy converter and the time-dependent overall deformation state;
determining internal load spectra at relevant positions of the wind turbine; and
determining or estimating at least one of a current lifetime use and a remaining lifetime by comparing the determined internal load spectra with a corresponding maximum supportable internal load spectra.

10. The method according to claim 9, wherein a number of the sensors corresponds at least to a number of relevant eigenvectors whose participation factors are determined.

11. The method according to claim 1, wherein the movements or oscillations of the components of the wind turbine are determined by superpositions of the time-dependent participation factors, in order to form a time-dependent overall deformation state.

12. The method according to claim 4, wherein continuously determining the internal variables acting in the wind turbine includes continuously determining at least one of internal forces and internal moments acting on the wind turbine.

13. The method according to claim 9, wherein the movements or oscillations of the components of the wind turbine are movements or oscillations of a tower and rotor blades of the wind turbine.
